(19) United States
(12) Patent Application Publication
(10) Pub. No.: US 2013/0126751 A1
(43) Pub. Date: May 23, 2013

(54) OPTICAL DEVICE, LASER APPARATUS, AND EXTREME ULTRAVIOLET LIGHT GENERATION SYSTEM

(71) Applicants: Hakaru Mizoguchi, Oyama-shi (JP); Osamu Wakabayashi, Hiratsuka-shi (JP)

(72) Inventors: Hakaru Mizoguchi, Oyama-shi (JP); Osamu Wakabayashi, Hiratsuka-shi (JP)

(73) Assignee: GIGAPHOTON INC., Oyama-shi, Tochigi (JP)

(21) Appl. No.: 13/809,576

(22) PCT Filed: Nov. 23, 2011
(86) PCT No.: PCT/IB2011/002794

§ 371 Date: Jan. 10, 2013

(30) Foreign Application Priority Data
Nov. 29, 2010 (JP) 2010-265786

(51) Int. Cl. F21V 5/04; G01N 21/55; F21V 11/02; F21V 7/00; F21V 7/06

(52) U.S. Cl. CPC F21V 5/04; F21V 7/00; F21V 7/06; F21V 11/02; G01N 21/55
USPC 250/453.11; 362/259

(57) ABSTRACT

An optical device may include: a first beam shaping unit configured to transform a first laser beam incident thereon into a second laser beam having an annular cross section; and a first focusing optical element for focusing the second laser beam in a first predetermined location so as to generate a Bessel beam.

### CROSS-REFERENCE TO RELATED APPLICATION

The present application claims priority from Japanese Patent Application No. 2010-265786 filed Nov. 29, 2010.

### BACKGROUND

1. Technical Field

This disclosure relates to an optical device, a laser apparatus, and an extreme ultraviolet light generation system.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication at 32 nm or less, for example, an exposure apparatus is expected to be developed, in which an apparatus for generating extreme ultraviolet (EUV) light at a wavelength of approximately 13 nm is combined with a reduced projection reflective optical system.

Three kinds of apparatuses for generating EUV light have been known in general, which include an LPP (Laser Produced Plasma) type apparatus in which plasma generated by irradiating a target material with a laser beam is used, a DPP (Discharge Produced Plasma) type apparatus in which plasma generated by electric discharge is used, and an SR (Synchrotron Radiation) type apparatus in which orbital radiation is used.

### SUMMARY

An optical device according to one aspect of this disclosure may include: a first beam shaping unit configured to transform a first laser beam incident thereon into a second laser beam having an annular cross section; and a first focusing optical element for focusing the second laser beam in a first predetermined location so as to generate a Bessel beam.

A laser apparatus according to another aspect of this disclosure may include: the above optical device; and at least one laser unit.

An extreme ultraviolet light generation system according to yet another aspect of this disclosure may include: the above optical device; a laser apparatus including at least one laser unit; a chamber provided with at least one inlet for introducing a laser beam outputted from the laser apparatus into the chamber; a target supply unit for supplying into the chamber a target material to be irradiated by the laser beam in the chamber; and a collector mirror for selectively reflecting, of light generated as the target material is irradiated by the laser beam, light at a predetermined wavelength.

### BRIEF DESCRIPTION OF THE DRAWINGS

FIG. 1 schematically shows the configuration of an EUV light generation system according to a first embodiment.

FIG. 2 shows an example of a beam shaping unit according to the first embodiment.

FIG. 3 is a sectional view of the beam shaping unit shown in FIG. 2, taken along a plane containing a beam axis of a laser beam.

FIG. 4 shows an example of a concave axicon mirror according to the first embodiment.

FIG. 5 shows a laser beam reflected by the concave axicon mirror shown in FIG. 4.

FIG. 6 schematically shows the configuration of an EUV light generation system according to a second embodiment.

FIG. 7 shows an example of an axicon lens according to the second embodiment.

FIG. 8 shows a Bessel beam generated around a plasma generation region according to the second embodiment.

FIG. 9 schematically shows the configuration of an EUV light generation system according to a third embodiment.

FIG. 10 shows an example of a diffraction grating according to the third embodiment.

FIG. 11 shows a Bessel beam generated around a plasma generation region according to the third embodiment.

FIG. 12 schematically shows the configuration of an EUV light generation system according to a fourth embodiment.

FIG. 13 schematically shows the configuration of an EUV light generation system according to a fifth embodiment.

FIG. 14 schematically shows the configuration of a window according to the fifth embodiment.

FIG. 15 shows an example of a hollow main pulse laser beam and a hollow pre-pulse laser beam.

FIG. 16 shows a beam shaping unit according to a first modification.

FIG. 17 is a sectional view of the beam shaping unit shown in FIG. 16.

FIG. 18 shows a beam shaping unit according to a second modification.

FIG. 19 is a sectional view of the beam shaping unit shown in FIG. 18.

FIG. 20 shows a beam shaping unit according to a third modification.

FIG. 21 is a sectional view of the beam shaping unit shown in FIG. 20.

### DESCRIPTION OF PREFERRED EMBODIMENTS

Hereinafter, selected embodiments for implementing this disclosure will be described in detail with reference to the accompanying drawings. In the description to follow and the accompanying drawings, each drawing merely illustrates examples of the shape, size, positional relationship, and so on, of the elements schematically shown, to the extent that enables the content of this disclosure to be understood; thus, this disclosure is not limited to the particular shape, size, positional relationship, and so on, of elements illustrated in each drawing. In order to show the configuration clearly, part of hatching along a section may be omitted in the drawings. Further, numerical values or ranges indicated herein are merely preferred examples of this disclosure; thus, this disclosure is not limited to the indicated numerical values or ranges.

### First Embodiment

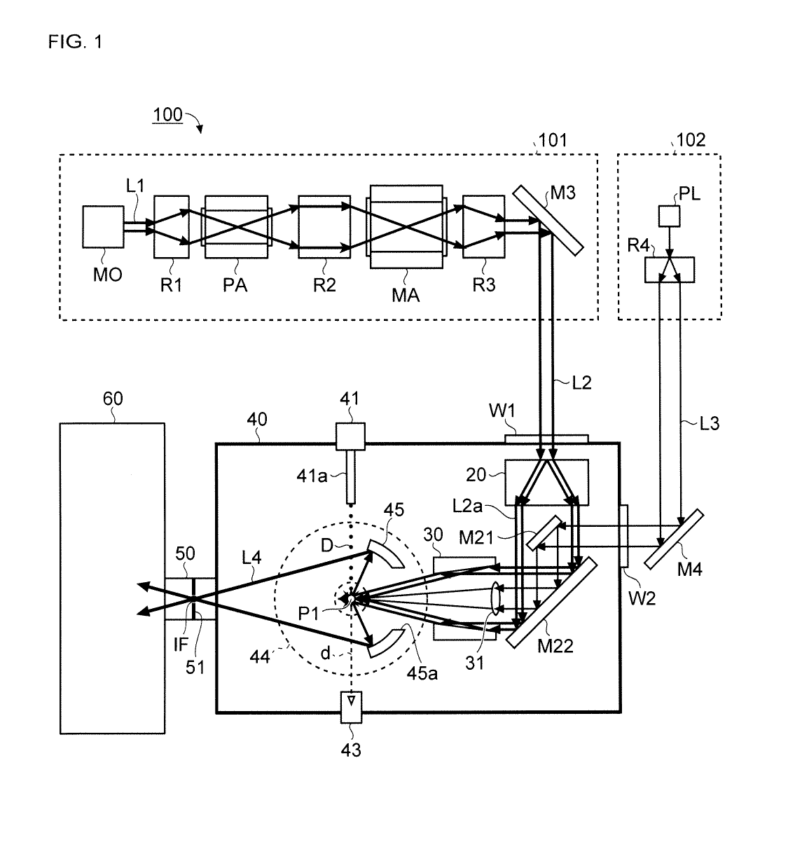

A first embodiment of this disclosure will be described in detail with reference to the drawings. FIG. 1 schematically shows the configuration of an EUV light generation system according to the first embodiment. An EUV light generation system 100 may include a driver laser 101, a pre-pulse laser 102, and a chamber 40.

### Driver Laser

The driver laser 101 may include a master oscillator MO, relay optical systems R1 through R3, a preamplifier PA, a main amplifier MA, and a high-reflection mirror M3.

The master oscillator MO may be configured to output a pulsed laser beam as a seed beam L1. A semiconductor laser, such as a quantum cascade laser and a distributed feedback semiconductor laser, may be used for the master oscillator MO, for example. However, various other types of lasers may be used, such as a solid-state laser or a gas laser.

The seed beam L1 outputted from the master oscillator MO may then have the beam diameter thereof expanded by the relay optical system R1 and thereafter enter the preamplifier PA. The preamplifier PA may, for example, be a laser amplifier containing a CO₂ gas as a gain medium. The relay optical system R1 may be configured to expand the beam diameter of the seed beam L1 such that the seed beam L1 may be amplified in an amplification region of the preamplifier PA efficiently. The preamplifier PA may be configured to amplify, of the seed beam L1 having entered thereinto, a laser beam at a wavelength contained in at least one gain bandwidth specific to the gain medium thereinside, and output the amplified laser beam as a main pulse laser beam L2.

The main pulse laser beam L2 outputted from the master oscillator MO may then have the beam diameter thereof expanded and be collimated by the relay optical system R2, and thereafter enter the main amplifier MA. As with the preamplifier PA, the main amplifier MA may, for example, be a laser amplifier containing a CO₂ gas as a gain medium. The relay optical system R2 may be configured to expand the beam diameter of the main pulse laser beam L2 such that the main pulse laser beam L2 may be amplified in an amplification region of the main amplifier MA efficiently. As with the preamplifier PA, the main amplifier MA may be configured to amplify, of the laser beam L2 having entered thereinto, a laser beam at a wavelength contained in at least one gain bandwidth specific to the gain medium thereinside.

The main pulse laser beam L2 outputted from the main amplifier MA may be collimated by the relay optical system R3, reflected by the high-reflection mirror M3, and thereafter outputted from the driver laser 101. It should be noted that the relay optical system R3 and the high-reflection mirror M3 may not be included in the driver laser 101.

### Pre-Pulse Laser

The pre-pulse laser 102 may include a pre-pulse laser beam source PL and a relay optical system R4. The pre-pulse laser beam source PL may be configured to output a pulsed laser beam, as a pre-pulse laser beam L3, with which a target material (droplet D) supplied into the chamber 40 may be irradiated. Various types of lasers, such as a solid-state laser, a gas laser, and a fiber laser, may be used for the pre-pulse laser beam source PL, for example. The pre-pulse laser beam L3 outputted from the pre-pulse laser beam source PL may then have the beam diameter thereof expanded by the relay optical system R4, and thereafter be outputted from the pre-pulse laser 102.

### Chamber

The main pulse laser beam L2 outputted from the driver laser 101 may enter the chamber 40 via a window W1. The pre-pulse laser beam L3 outputted from the pre-pulse laser 102 may enter the chamber 40 via a window W2. The chamber 40 may be provided with a beam shaping unit 20, a concave axicon mirror 30, and a focusing lens 31. The chamber 40 may further be provided with a droplet generator 41, a droplet collection unit 43, electromagnetic coils 44, and an EUV collector mirror 45.

### Window

A transparent substrate, such as a diamond substrate, which excels in thermal stability and has a high transmission factor for the main pulse laser beam L2 and the pre-pulse laser beam L3, may preferably be used for the windows W1 and W2. The windows W1 and W2 may preferably be inclined 3 to 5 degrees with respect to beam axes of the laser beams incident thereon so that the laser beams reflected at the surfaces thereof may not form a hot-spot on a surface of an optical element in the optical systems, such as the relay optical systems R3 and R4, disposed upstream of the windows W1 and W2.

### Beam Shaping Unit

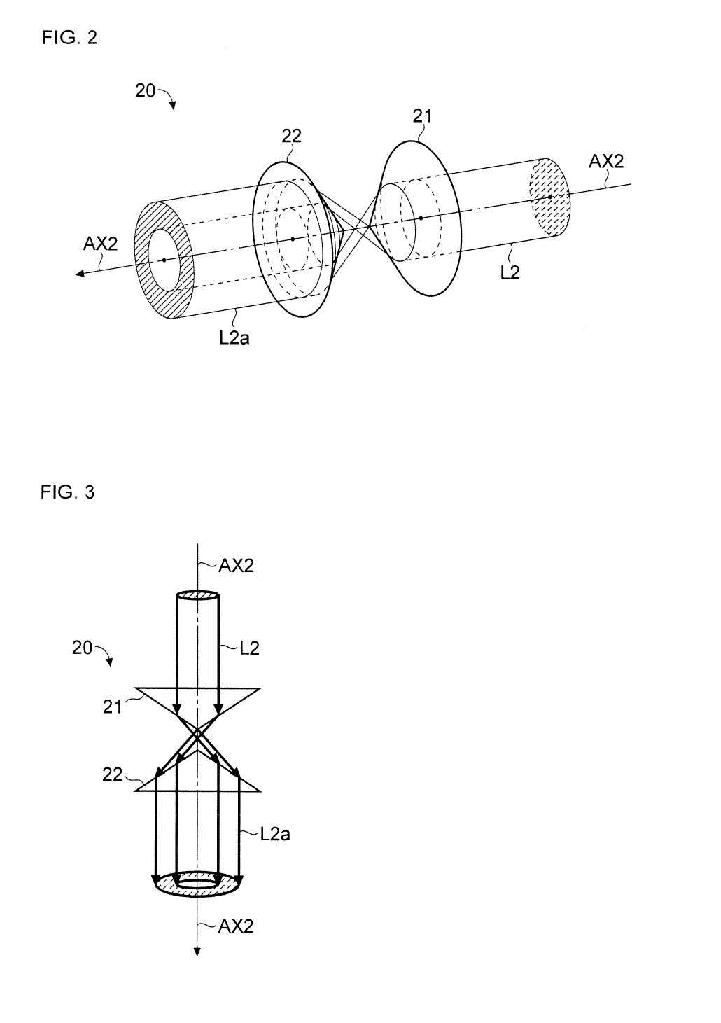

The main pulse laser beam L2 having entered the chamber 40 via the window W1 may be transformed into a hollow main pulse laser beam L2a, of which the cross-section is annular in shape, by the beam shaping unit 20. FIGS. 2 and 3 show an example of the beam shaping unit according to the first embodiment. FIG. 3 is a cross-sectional view of the beam shaping unit shown in FIG. 2, taken along a plane containing an axis AX2 of the laser beam. As shown in FIG. 2, the beam shaping unit 20 may include two axicon lenses 21 and 22, which in some examples may be transmissive lenses and/or convex axicon lenses. As shown in FIG. 3, the axicon lenses 21 and 22 may be disposed such that the conical surfaces of axicon lenses 21 and 22 face each other and the vertices of the conical surfaces of the lenses 21 and 22 are separated by a predetermined gap. Further, the axicon lenses 21 and 22 may preferably be disposed such that extensions of the respective optical axes thereof substantially coincide with each other. With the beam shaping unit 20 configured as described above, when the main pulse laser beam L2, of which the cross section is circular in shape, is incident, for example, on the bottom surface of the axicon lens 21 (e.g., the non-conical surface of axicon lens 21, or the surface of axicon lens 21 opposite the conical surface), the hollow main pulse laser beam L2a, of which the cross section is annular in shape, may be outputted from the bottom surface of the axicon lens 22 (e.g., the non-conical surface of axicon lens 22, or the surface of axicon lens 22 opposite the conical surface). In this configuration, controlling the distance between the vertices of the conical surfaces of axicon lenses 21 and 22 may make it possible to control the inner and outer diameters of the hollow main pulse laser beam L2a. Here, the main pulse laser beam L2 may preferably be incident on the bottom surface (e.g., non-conical surface, or surface opposite the conical surface) of the axicon lens 21 substantially perpendicularly. Further, the axicon lenses 21 and 22 may preferably be provided with anti-reflection coatings, respectively, at the surfaces thereof.

### Concave Axicon Mirror

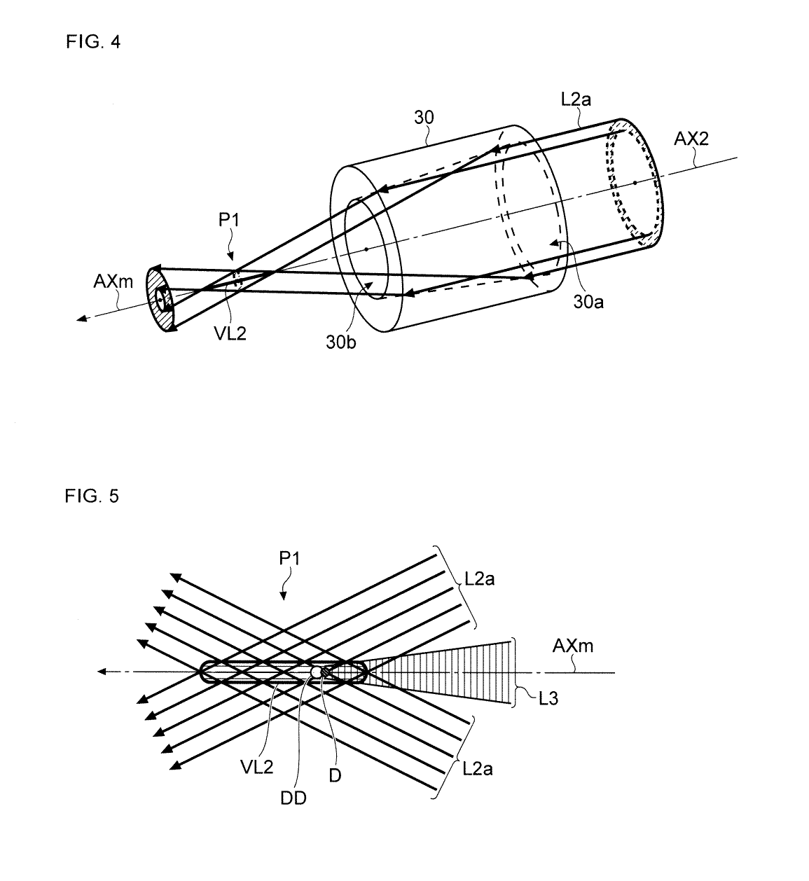

The hollow main pulse laser beam L2a may be reflected by a high-reflection mirror M22 and then be incident on the concave axicon mirror 30 in the focusing optical system. FIG. 4 shows an example of the concave axicon mirror. FIG. 5 shows a laser beam reflected by the concave axicon mirror shown in FIG. 4. As shown in FIG. 4, the concave axicon mirror 30 may include a cylindrical member having a truncated-conical hollow part thereinside. The concave axicon mirror 30 may be configured such that the inner diameter at one end 30a of mirror 30 is larger than the diameter at the other end 30b of mirror 30. The hollow main pulse laser beam L2a shaped by the beam shaping unit 20 may be incident on the concave axicon mirror 30 from the side of the end 30a having the larger diameter. The hollow main pulse laser beam L2a may be reflected on the inner circumferential surface of the concave axicon mirror 30, to thereby emerge from a through-hole formed in the end 30b of the mirror 30 having the smaller diameter and be focused while remaining in a collimated state. As the hollow main pulse laser beam L2a is focused, a so-called Bessel beam VL2 may be generated in a region where the hollow main pulse laser beam L2a is focused. Here, the axis of the hollow main pulse laser beam L2a incident on the concave axicon mirror 30 may preferably coincide with the axis AXm of the concave axicon mirror 30. With this, the Bessel beam VL2 may be generated along the axis of the hollow main pulse laser beam L2a. Generating the Bessel beam VL2 may allow the depth of focus of the main pulse laser beam L2 to be increased, which may reduce influence on the irradiation accuracy even when the target material is displaced along the axis of the laser beam. In the first embodiment, the hollow main pulse laser beam L2a may be focused around the plasma generation region P1. With this, it is contemplated that the target material (such at the droplet D or a diffused target DD transformed from the droplet D) may be irradiated by the main pulse laser beam L2 more reliably.

Meanwhile, the pre-pulse laser beam L3 (See FIG. 1) outputted from the pre-pulse laser 102 may be reflected by the high-reflection mirror M4 and then enter the chamber 40 via the window W2. The pre-pulse laser beam L3 having entered the chamber 40 may be reflected by the high-reflection mirror M21. The high-reflection mirror M21 may be disposed within a hollow part of the hollow main pulse laser beam L2a along the beam path thereof. More specifically, the high-reflection mirror M21 may be disposed between the beam shaping unit 20 and the high-reflection mirror M22 so as not to block the hollow main pulse laser beam L2a. The pre-pulse laser beam L3 may be reflected by the high-reflection mirror M21 and then be reflected, as with the hollow main pulse laser beam L2a, by the high-reflection mirror M22. The pre-pulse laser beam L3 reflected by the high-reflection mirror M22 may be incident on the focusing lens 31 (See FIG. 1).

### Focusing Lens

The focusing lens 31 may be disposed in the hollow part of the hollow main pulse laser beam L2a along the beam path thereof. The focusing lens 31 may preferably be smaller in diameter than the inner diameter of the concave axicon mirror 30. The focusing lens 31 may preferably be disposed such that the optical axis thereof substantially coincides with the axis AXm of the concave axicon mirror 30. The focusing lens 31 may be configured to focus the pre-pulse laser beam L3 incident thereon around the plasma generation region P1. The pre-pulse laser beam L3 may travel through the hollow part of the concave axicon mirror 30 and be focused around the plasma generation region P1. That is, the pre-pulse laser beam L3 may travel toward the plasma generation region P1 in the same direction as the main pulse laser beam L2 (from the side of the EUV collector mirror 45) and be focused therearound. Note that the foci of the main pulse laser beam L2 and the pre-pulse laser beam L3 may not coincide with each other.

### Droplet Generator

Referring again to FIG. 1, the droplet generator 41 may be configured to supply the target material (such as Sn) to be turned into plasma in or around the plasma generation region P1. The droplet generator 41 may be configured to supply the target material in the form of one or more droplets D. More specifically, the droplet generator 41 may be configured such that Sn serving as the target material is stored thereinside in a molten state and molten Sn is outputted in the form of the droplet D toward the plasma generation region P1 through a nozzle 41a.

### Diffused Target (Pre-Plasma and Scattered Target)

The droplet D arriving in the plasma generation region P1 may be irradiated by the pre-pulse laser beam L3. The droplet D, having been irradiated by the pre-pulse laser beam L3, may be transformed into the diffused target DD. The diffused target DD, herein, may be defined as a state of a target containing at least one of pre-plasma and a scattered target. The pre-plasma may refer to a plasma state or a state in which plasma and atoms in a gaseous state are mixed and coexist therein. The scattered target may refer to a particulate group containing fine particulates such as clusters and micro-droplets of the target material scattered by being irradiated by the laser beam, or to a fine particulate group in which the fine particulates are mixed and coexist.

The diffused target DD may be irradiated by the main pulse laser beam L2 (e.g., by the Bessel beam VL2). With this, the diffused target DD may be turned into plasma. Light containing EUV light L4 at a predetermined wavelength (13.5 nm, for example) may be emitted from the plasma. Part of the EUV light L4 may be incident on the EUV collector mirror 45.

### EUV Collector Mirror

The EUV collector mirror 45 may, of the light incident thereon, selectively reflect the EUV light L4 at the predetermined wavelength. The EUV collector mirror 45 may be configured to focus the EUV light L4 selectively reflected thereby in a predetermined site (intermediate focus IF, for example). The EUV collector mirror 45 may preferably be provided with a through-hole 45a at substantially the center thereof. The pre-pulse laser beam L3 and the main pulse laser beam L2 may be focused around the plasma generation region P1 via the through-hole 45a. Accordingly, the pre-pulse laser beam L3 and the main pulse laser beam L2 may travel in the same direction from the side of the EUV collector mirror 45 toward the plasma generation region P1 and be focused therearound.

### Exposure Apparatus Connection and Exposure Apparatus

The intermediate focus IF may be set inside an exposure apparatus connection 50 configured to connect the chamber 40 to an exposure apparatus 60. The exposure apparatus connection 50 may be provided with a partition wall 51 with a pinhole formed therein. The EUV light L4 focused in the intermediate focus IF may travel through the pinhole and then be propagated to the exposure apparatus 60 via an optical system (not shown).

### Droplet Collection Unit

A droplet D which is not irradiated by the pre-pulse laser beam L3 or the main pulse laser beam L2 in the plasma generation region P1, or a target material which has not been turned into plasma may be collected in the droplet collection unit 43, for example.

### Magnetic Field Mitigation (Electromagnetic Coils)

A magnetic field may be generated around the plasma generation region P1 for trapping debris generated when the target material is turned into plasma. The magnetic field may be generated using the electromagnetic coils 44, for example. Here, the direction of the magnetic field may differ from the direction in which the droplet D may travel. Debris collection units (not shown) may respectively be provided at two locations along the direction of the magnetic field opposing each other with the plasma generation region P1 therebetween. The debris trapped in the magnetic field may move in the direction of the magnetic field while being in Larmor (cyclotron) movement, thereby being collected into the debris collection units.

According to the first embodiment, the Bessel beam VL2 of the main pulse laser beam L2 may be generated around the plasma generation region P1; thus, the depth of focus of the main pulse laser beam L2 may be increased. With this, it is contemplated that influence on the irradiation accuracy even when the target material is displaced along the axis of the laser beam may be reduced, and the target material (such at the droplet D or the diffused target DD transformed from the droplet D) may be irradiated by the main pulse laser beam L2 more reliably. Further, increasing the depth of focus may reduce the need for adjusting the focus of the main pulse laser beam L2 by adjusting the focusing optical system.

Further, according to the first embodiment, the main pulse laser beam L2 may be transformed into the hollow main pulse laser beam L2a, which may make it possible to irradiate the target material with the pre-pulse laser beam L3 and the main pulse laser beam L2 in substantially the same direction without using a combining optical element such as a dichroic mirror. With this, an energy loss which may occur at the combining optical element can be reduced. The target material may be irradiated by the pre-pulse laser beam L3 and the main pulse laser beam L2 in substantially the same direction, whereby the target material may be turned into plasma more efficiently. As a result, an energy conversion efficiency (CE) into the EUV light L4 may be improved, and high-output EUV light L4 may be obtained.

### Second Embodiment

A second embodiment of this disclosure will be described in detail with reference to the drawings. In the description to follow, configurations similar to those of the first embodiment are referenced by similar reference symbols, numerals, and names, and duplicate description thereof will be omitted.

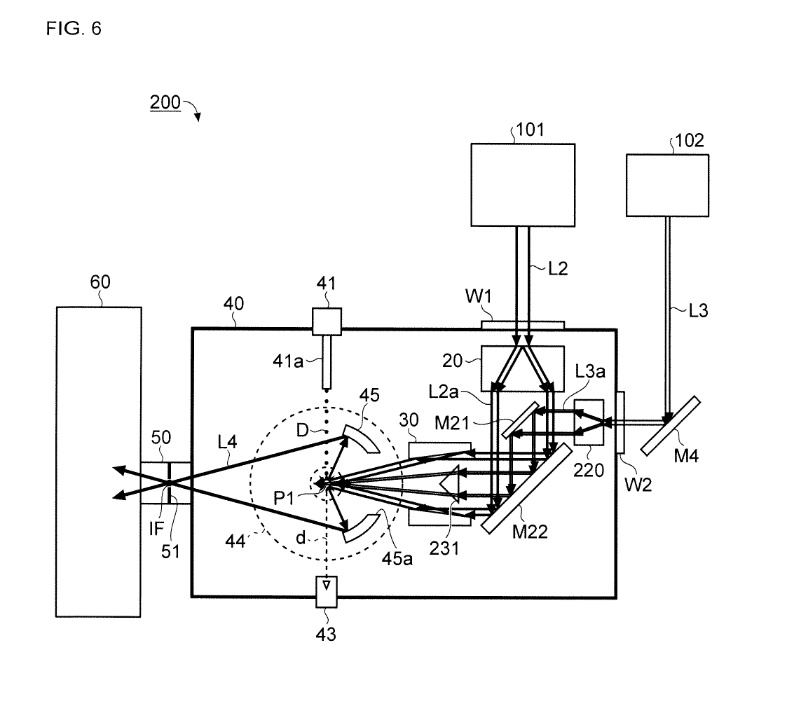

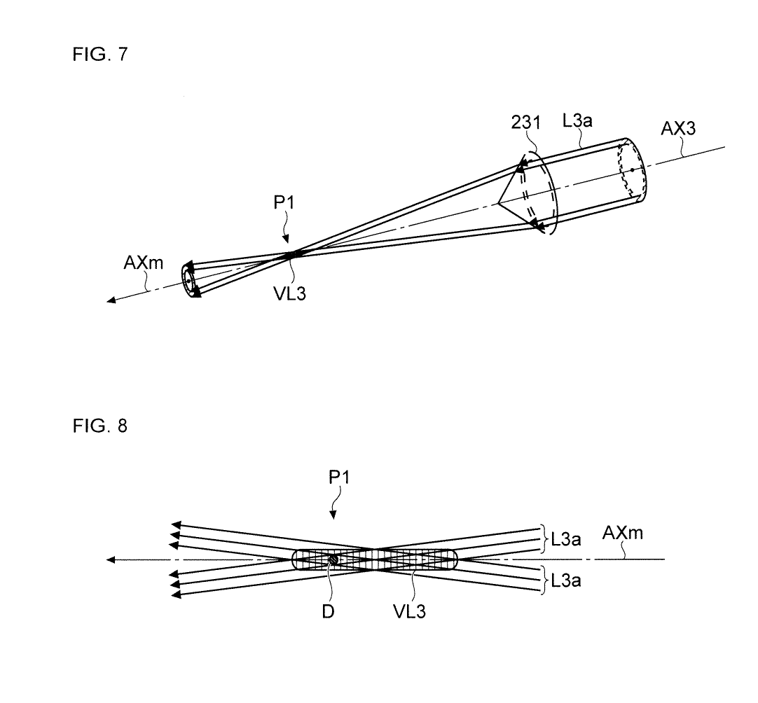

FIG. 6 schematically shows the configuration of an EUV light generation system according to the second embodiment. As it may be apparent when FIGS. 1 and 6 are compared, an EUV light generation system 200 (FIG. 6) may be similar in configuration to the EUV light generation system 100 (FIG. 1). In the EUV light generation system 200, however, a Bessel beam VL3 (see, e.g., FIGS. 7 and 8) of the pre-pulse laser beam L3 may be generated around the plasma generation region P1. Accordingly, the EUV light generation system 200 may include a beam shaping unit 220 configured to transform the pre-pulse laser beam L3 into a hollow pre-pulse laser beam L3a, and the focusing lens 31 in the EUV light generation system 100 may be replaced by an axicon lens 231 configured to focus the hollow pre-pulse laser beam L3a around the plasma generation region P1 while maintaining the hollow pre-pulse laser beam L3a in a collimated state.

### Beam Shaping Unit for Pre-Pulse Laser Beam

The beam shaping unit 220 may be configured similarly to the beam shaping unit 20 shown in FIGS. 2 and 3. The hollow pre-pulse laser beam L3a transformed by the beam shaping unit 220 may be reflected by the high-reflection mirrors M21 and M22 and then be incident on the axicon lens 231.

### Axicon Lens

FIG. 7 shows an example of the axicon lens. The hollow pre-pulse laser beam L3a may be incident on the bottom (i.e., non-conical) face of the axicon lens 231 (e.g., a convex axicon lens). The hollow pre-pulse laser beam L3a may preferably be incident on the axicon lens 231 such that the axis of the hollow pre-pulse laser beam L3a substantially coincides with the rotational axis of the axicon lens 231. As the hollow pre-pulse laser beam L3a is outputted from the inclined surface (i.e., the conical surface) of the axicon lens 231, the hollow pre-pulse laser beam L3a may be focused while remaining in a collimated state. By focusing the hollow pre-pulse laser beam L3a, the Bessel beam VL3 may be generated, as shown in FIG. 8, in a region where the hollow pre-pulse laser beam L3a is focused. The Bessel beam VL3 may be generated along the axis of the hollow pre-pulse laser beam L3a. In this way, generating the Bessel beam VL3 may make it possible to increase the depth of focus of the pre-pulse laser beam L3. In the second embodiment, the hollow pre-pulse laser beam L3a may be focused around the plasma generation region P1. With this, the target material (for example, droplet D) may be irradiated by the pre-pulse laser beam L3 more reliably. Note that the focusing optical systems (e.g., concave axicon mirror 30 and axicon lens 231) may be disposed such that the region in which the Bessel beam VL3 is generated may at least partially overlap the region in which the Bessel beam VL2 is generated (e.g., such that the region in which the Bessel beam VL3 is generated may substantially coincide with the region in which the Bessel beam VL2 is generated, or such that the region in which the Bessel beam VL3 is generated may differ from the region in which the Bessel beam VL2 is generated).

Other configurations and effects may be similar to those of the above-described first embodiment; thus, detailed description thereof will be omitted.

### Third Embodiment

A third embodiment of this disclosure will be described in detail with reference to the drawings. In the description to follow, configurations similar to those of the first or second embodiment are referenced by similar reference symbols, numerals, and names, and duplicate description thereof will be omitted.

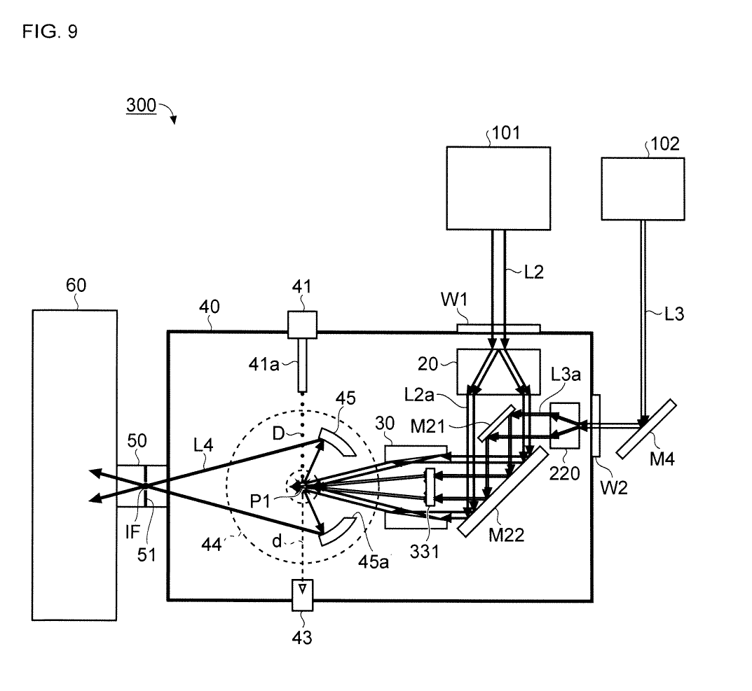

FIG. 9 schematically shows the configuration of an EUV light generation system according to the third embodiment. As it may be apparent when FIGS. 6 and 9 are compared, an EUV light generation system 300 (FIG. 9) may be similar in configuration to the EUV light generation system 200 (FIG. 6). However, in the EUV light generation system 300, the axicon lens 231 in the EUV light generation system 200 may be replaced with a diffraction grating 331 provided with a plurality of concentric grooves.

### Diffraction Grating

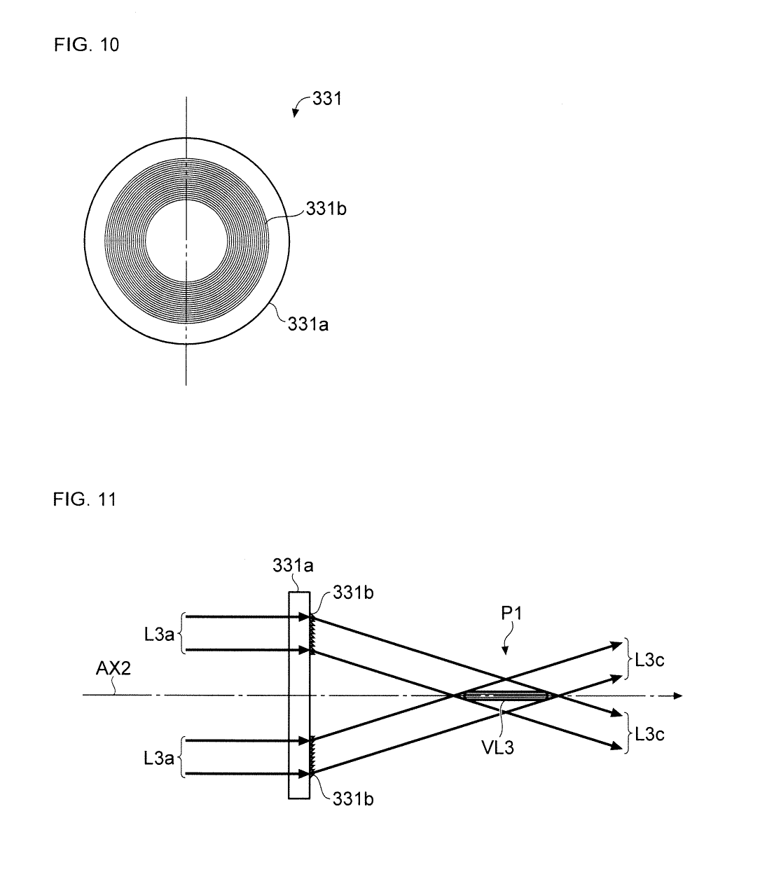

FIG. 10 shows an example of a diffraction grating. As shown in FIG. 10, the diffraction grating 331 may include a diffraction part 331b including a plurality of concentric grooves formed in a surface of a disc-shaped transparent substrate 331a. The transparent substrate 331a may be a diamond substrate, for example. The inner and outer diameters of the diffraction part 331b may preferably coincide with the inner and outer diameters of the hollow pre-pulse laser beam L3a. The diffraction grating 331 may preferably be disposed such that the axis thereof substantially coincides with the axis AXm of the concave axicon mirror 30.

The hollow pre-pulse laser beam L3a may be incident on the other surface (i.e., the surface opposite the surface having the concentric grooves formed therein) of the transparent substrate 331a substantially perpendicularly to the other surface. As the hollow pre-pulse laser beam L3a is outputted from the diffraction part 331b of the diffraction grating 331, a diffracted beam L3c of the hollow pre-pulse laser beam L3a may be focused around the plasma generation region P1, as shown in FIG. 11. As a result, the Bessel beam VL3 may be generated around the plasma generation region P1 along the axis of the hollow pre-pulse laser beam L3a. In this way, generating the Bessel beam VL3 may make it possible to increase the depth of focus of the pre-pulse laser beam L3, as in the second embodiment. As a result, the target material (for example, droplet D) may be irradiated by the pre-pulse laser beam L3 more reliably.

Other configurations and effects may be similar to those of the above-described first or second embodiment; thus, detailed description thereof will be omitted.

### Fourth Embodiment

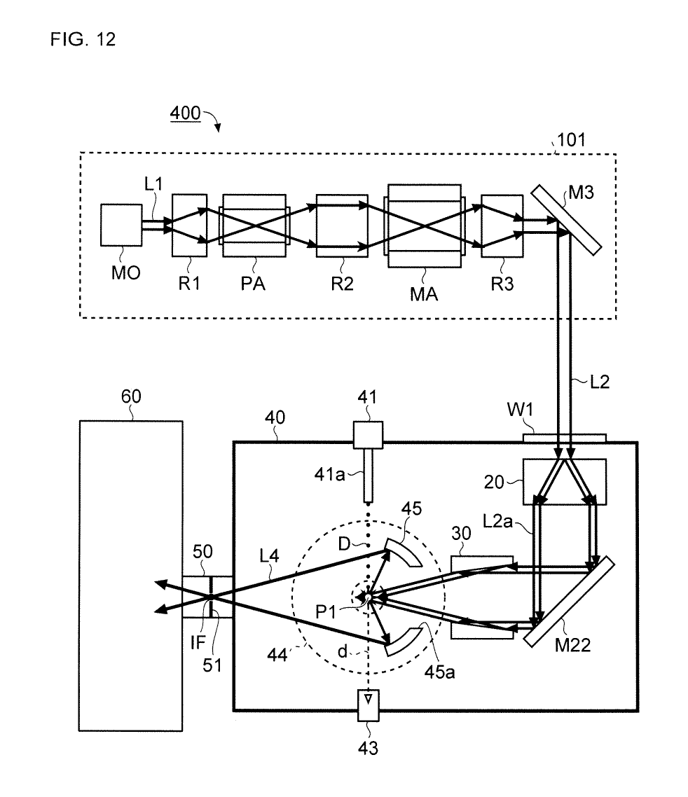

In the above-described embodiments, the target material may be turned into plasma using two-stage laser irradiation. However, without being limited thereto, the target material may be turned into plasma using single-stage laser irradiation. FIG. 12 schematically shows the configuration of an EUV light generation system according to a fourth embodiment. In the description to follow, configurations similar to those of any of the first through third embodiments are referenced by similar reference symbols, numerals, and names, and duplicate description thereof will be omitted. The description to follow is based on the first embodiment. However, the fourth embodiment may also be applied to the second or third embodiment.

As it may be apparent when FIGS. 1 and 12 are compared, an EUV light generation system 400 (FIG. 12) may be similar in configuration to the EUV light generation system 100 (FIG. 1); however, the pre-pulse laser 102 and the focusing optical system (high-reflection mirror M21 and focusing lens 31) for focusing the pre-pulse laser beam L3 around the plasma generation region P1 may be omitted. Even in a case where the target material (droplet D) is turned into plasma with only the main pulse laser beam L2, by generating the Bessel beam VL2 of the main pulse laser beam L2 around the plasma generation region P1, the target material (for example, droplet D) may be irradiated by the main pulse laser beam L2 more reliably.

Other configurations and effects may be similar to those of any of the above-described first through third embodiments; thus, detailed description thereof will be omitted.

### Fifth Embodiment

A fifth embodiment of this disclosure will be described in detail with reference to the drawings. In the description to follow, configurations similar to those of any of the first through fourth embodiments are referenced by similar reference symbols, numerals, and names, and duplicate description thereof will be omitted. The description to follow is based on the first embodiment. However, the fifth embodiment may also be applied to any of the second through fourth embodiments.

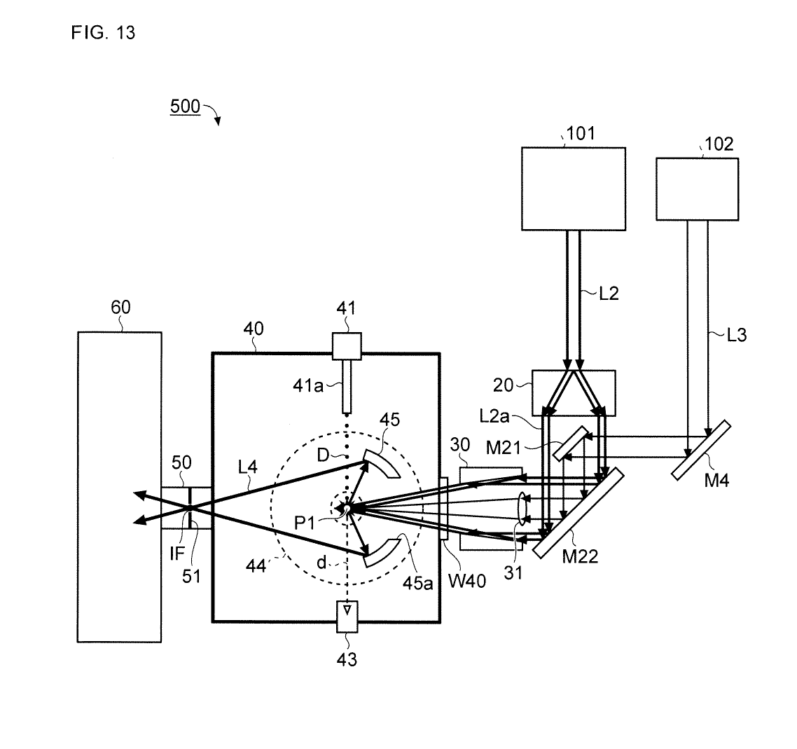

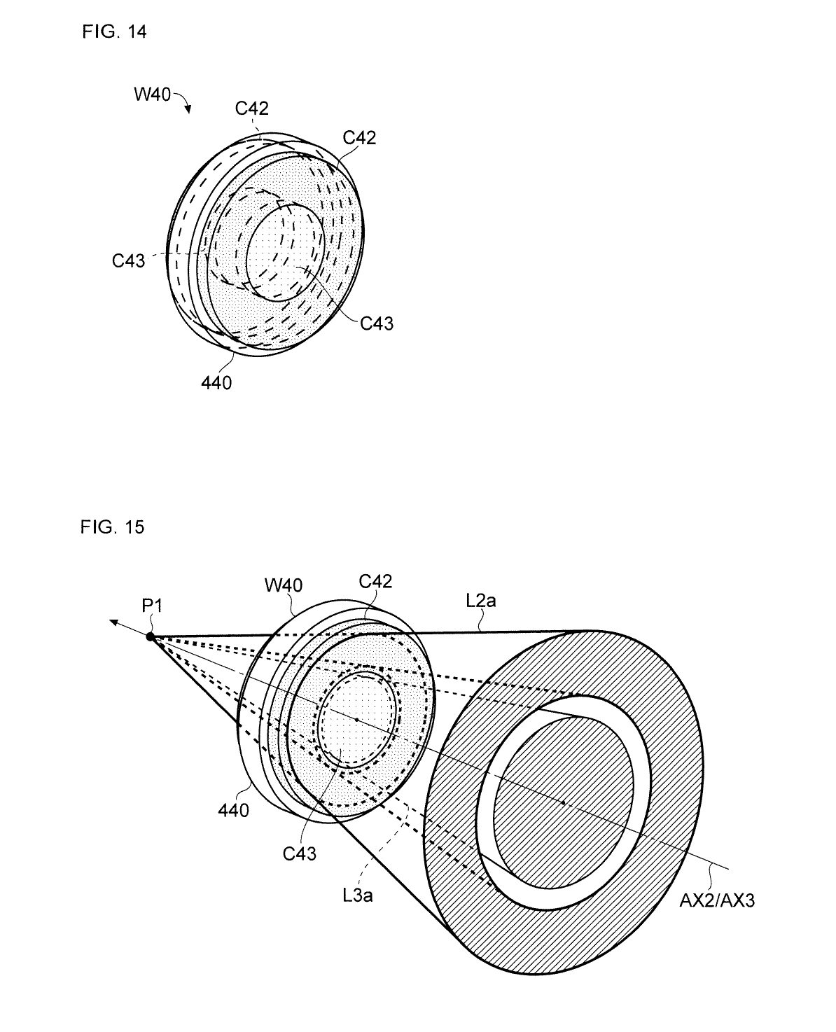

FIG. 13 schematically shows the configuration of an EUV light generation system according to the fifth embodiment. As shown in FIG. 13, in an EUV light generation system 500, the focusing optical systems (beam shaping unit 20, high-reflection mirrors M21 and M22, concave axicon mirror 30, and focusing lens 31) for focusing the main pulse laser beam L2 and the pre-pulse laser beam L3 around the plasma generation region may be disposed outside the chamber 40. Further, in the EUV light generation system 500, the window W1 in the EUV light generation system 100 may be omitted, and the window W2 may be replaced by a window W40.

### Window

FIG. 14 schematically shows the configuration of the window. FIG. 15 shows an example of the positional relationship between the window, the main pulse laser beam, and the pre-pulse laser beam. The window W40 may include a window substrate 440, such as a diamond substrate, for example. The window substrate 440 may be provided, at substantially the center of the flat surfaces thereof, with anti-reflection coatings C43 for improving the transmittance of the pre-pulse laser beam L3. The anti-reflection coatings C43 may be provided only in a central circular portion of the window substrate 440. The window substrate 440 may also be provided with anti-reflection coatings C42 for improving the transmittance of the main pulse laser beam L2, the anti-reflection coatings C42 being provided so as to surround the anti-reflection coatings C43, respectively. The anti-reflection coatings C42 may thus be provided in an annular region of the window substrate 440 surrounding a central circular region provided with the anti-reflection coatings C43.

As has been described so far, the configuration in which the focusing optical systems for focusing the main pulse laser beam L2 and the pre-pulse laser beam L3 around the plasma generation region P1 are disposed outside the chamber 40 may make it possible to prevent the debris from contaminating the above optical systems. However, not all of the beam shaping unit 20, the high-reflection mirrors M21 and M22, the concave axicon mirror 30, and the focusing lens 31 need to be disposed outside the chamber 40. That is, the configuration may be such that at least some of the optical elements are disposed outside the chamber 40.

Other configurations and effects may be similar to those of any of the above-described first through fourth embodiments; thus, detailed description thereof will be omitted.

### First Modification of Beam Shaping Unit

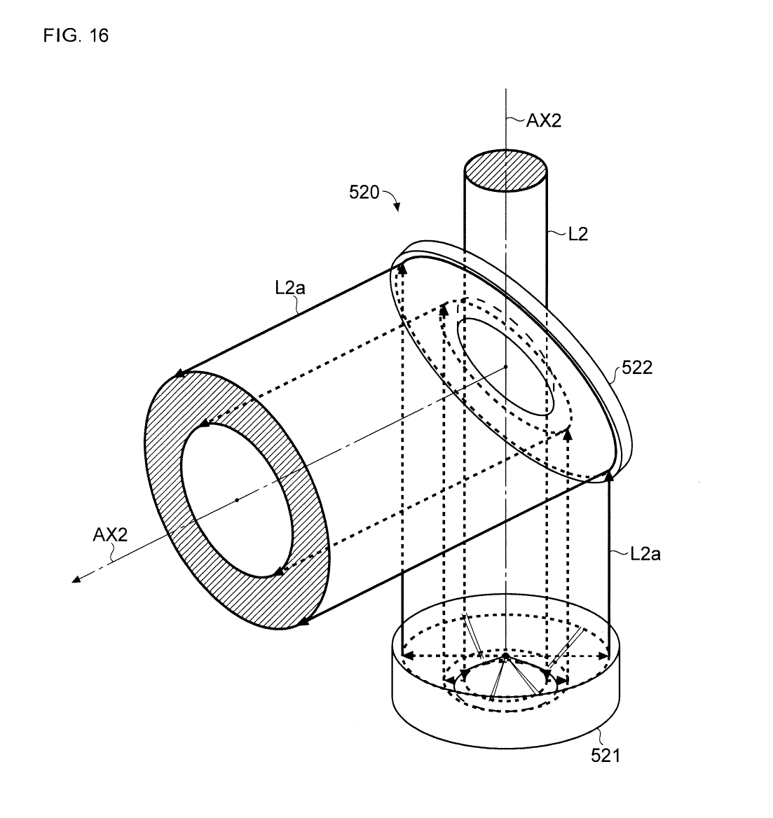

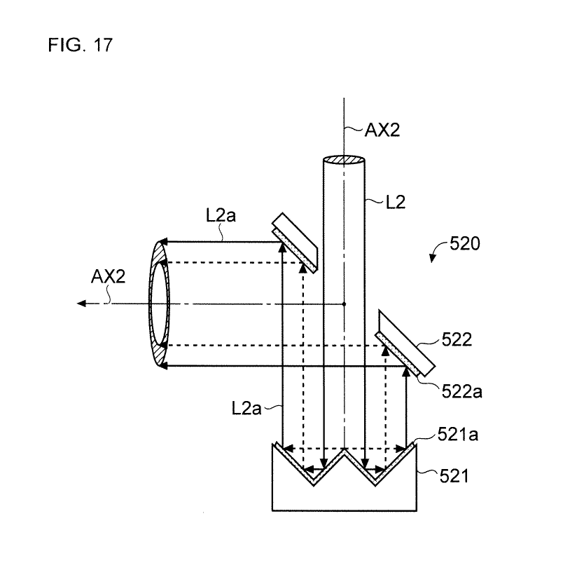

A first modification of the above-described beam shaping unit will be described. FIG. 16 shows abeam shaping unit according to the first modification. FIG. 17 is a cross-sectional view of the beam shaping unit shown in FIG. 16. As shown in FIGS. 16 and 17, a beam shaping unit 520 may include an axicon mirror 521 (e.g., a convex axicon mirror 521) and a flat mirror 522 provided with a through-hole. The axicon mirror 521 and the flat mirror 522 may be coated, on the respective reflective surfaces thereof, with reflective film coatings 521a and 522a for improving the reflectance of the surfaces used for reflecting the main pulse laser beam L2. In this way, configuring the beam shaping unit 520 with reflective optical elements may make it possible to reduce a heat load on the optical elements on which the main pulse laser beam L2 is incident, whereby the distortion of the wavefront of the laser beam reflected thereby may be suppressed.

### Second Modification of Beam Shaping Unit

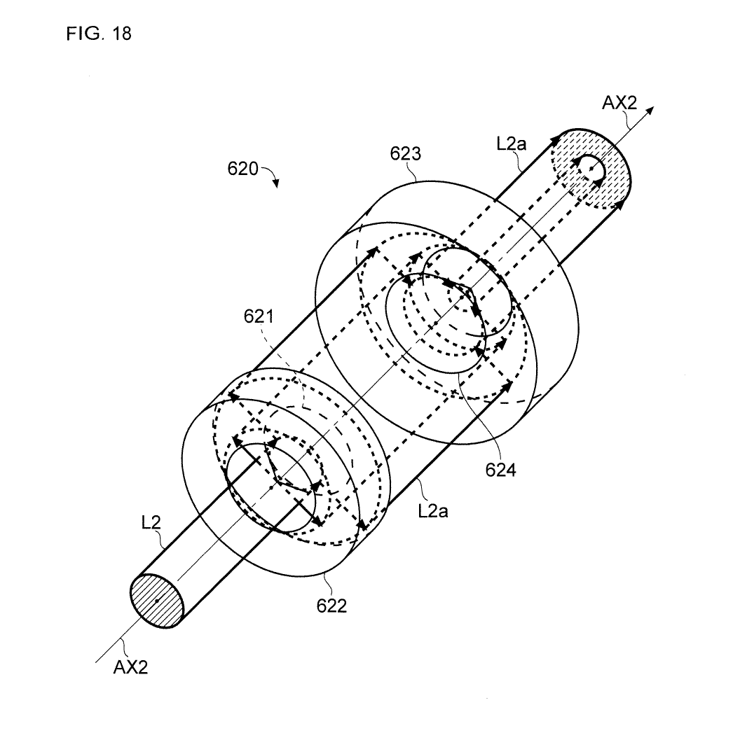

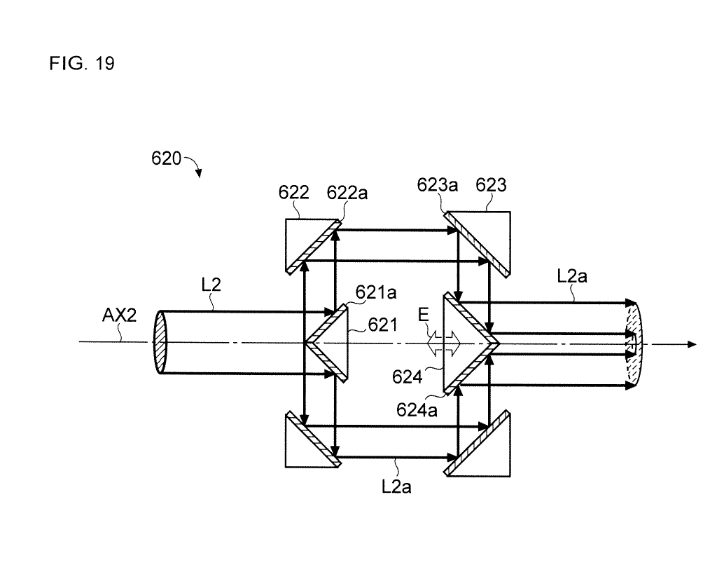

The above-described beam shaping unit may be modified as shown in FIGS. 18 and 19. As shown in FIGS. 18 and 19, abeam shaping unit 620 according to a second modification may include four axicon mirrors 621 through 624 (e.g., convex axicon mirrors 621 and 624, and concave axicon mirrors 622 and 623). The respective reflective surfaces may be coated with reflective film coatings 621a through 624a for improving the reflectance of the surfaces for reflecting the main pulse laser beam L2. In this configuration, the main pulse laser beam L2 may be transformed into the hollow main pulse laser beam L2a by the axicon mirrors 621 and 622. Then, the hollow main pulse laser beam L2a may have the diameter thereof be adjusted by the axicon mirrors 623 and 624. More specifically, moving the axicon mirror 624 in the direction shown with the arrow E in FIG. 19 with respect to the axicon mirror 623 may allow the diameter of the cross section of the hollow main pulse laser beam L2a outputted from the beam shaping unit 620 to be adjusted. According to the second modification, as with the first modification, configuring the beam shaping unit 620 with reflective optical elements may make it possible to reduce the energy loss at each optical element.

### Third Modification of Beam Shaping Unit

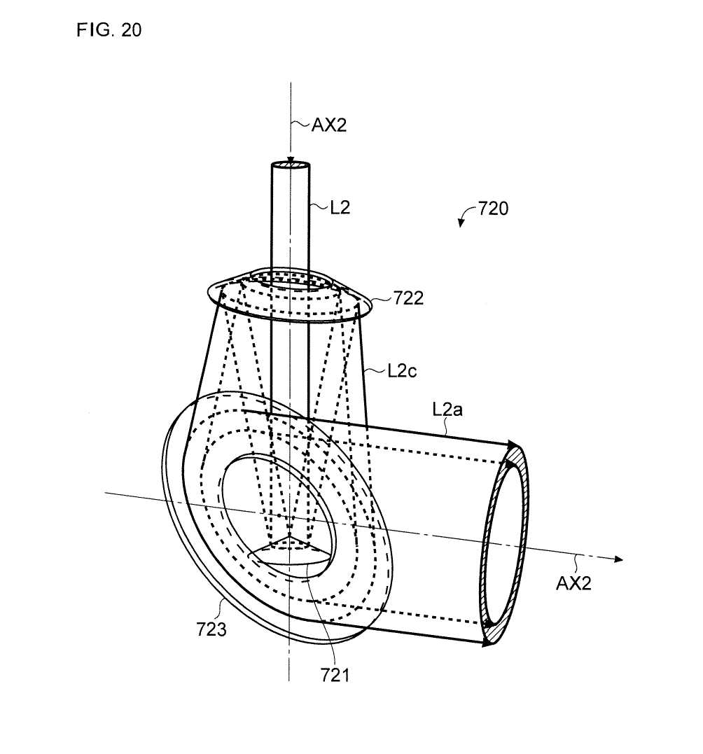

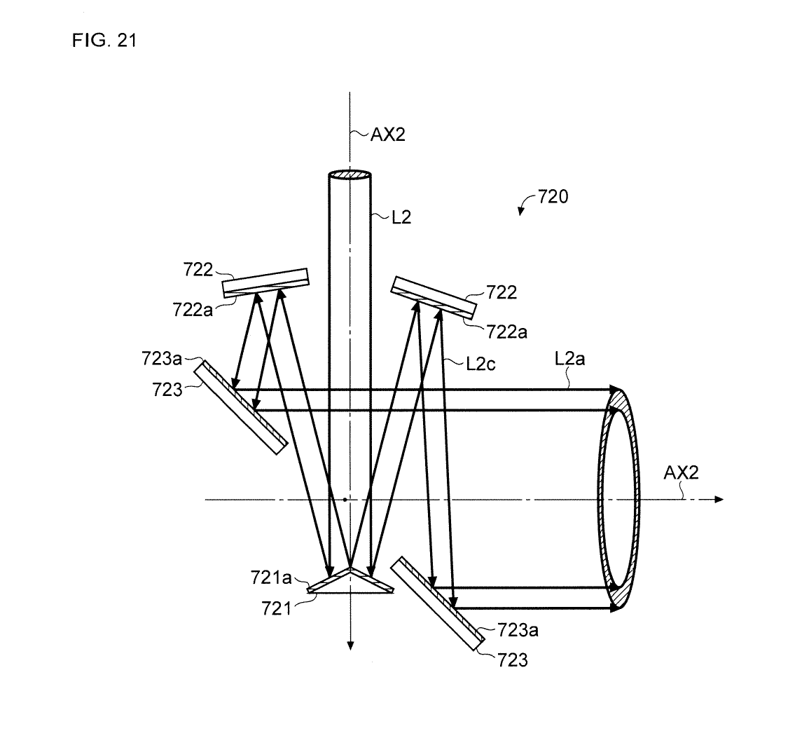

The above-described beam shaping unit may be modified as shown in FIGS. 20 and 21. As shown in FIGS. 20 and 21, abeam shaping unit 720 according to a third modification may include two axicon mirrors 721 and 722 (e.g., a convex axicon mirror 721 and a concave axicon mirror 722) and a flat mirror 723 provided with a through-hole. The respective reflective surfaces may be coated with reflective film coatings 721a through 723a for improving the reflectance of the surfaces for reflecting the main pulse laser beam L2. In this configuration, the main pulse laser beam L2 may be transformed into a conical hollow main pulse laser beam L2c by the axicon mirror 721. Then, the conical hollow main pulse laser beam L2c may be transformed into the hollow main pulse laser beam L2a by the flat mirror 723. In the third modification, as with the first and second modifications, the beam shaping unit 720 may include reflective optical elements, which may make it possible to reduce a heat load on the optical elements on which the main pulse laser beam L2 is incident, whereby the distortion of the wavefront of the laser beam reflected thereby may be suppressed.

The above-described modifications of the beam shaping unit may be adopted for either of the main pulse laser beam L2 and the pre-pulse laser beam L3.

It should be noted that it may be difficult to regulate the depth of focus when a hollow laser beam is focused by a focusing optical system having a curvature. On the contrary, when a Bessel beam is generated from a hollow laser beam using an axicon mirror or an axicon lens, the depth of focus may be regulated by controlling the difference between the inner and outer diameters of the hollow laser beam.

The above-described embodiments and the modifications thereof are merely examples for implementing this disclosure, and this disclosure is not limited thereto. Making various modifications according to the specifications or the like is within the scope of this disclosure, and it is apparent from the above description that other various embodiments are possible within the scope of this disclosure. For example, the modifications illustrated for each of the embodiments can be applied to other embodiments (including some of the other embodiments described herein) as well.

The terms used in this specification and the appended claims should be interpreted as “non-limiting.” For example, the terms “include” and “be included” should be interpreted as “including the stated elements but not being limited to the stated elements.” The term “have” should be interpreted as “having the stated elements but not being limited to the stated elements.” Further, the modifier “one (a/an)” should be interpreted as “at least one” or “one or more.”

1. An optical device, comprising:
a first beam shaping unit configured to transform a first laser beam incident thereon into a second laser beam having an annular cross section; and
a first focusing optical element for focusing the second laser beam in a first predetermined location so as to generate a Bessel beam.

2. The optical device according to claim 1, wherein the first beam shaping unit comprises a transmissive optical element.

3. The optical device according to claim 2, wherein the transmissive optical element is a convex axicon lens.

4. The optical device according to claim 1, wherein the first beam shaping unit comprises a reflective optical element.

5. The optical device according to claim 4, wherein the reflective optical element includes at least one of a concave axicon mirror and a convex axicon mirror.

6. The optical device according to claim 1, wherein the first focusing optical element comprises a concave axicon mirror provided with a through-hole in a direction of an optical axis thereof.

7. The optical device according to claim 1, further comprising:
a second beam shaping unit for transforming a third laser beam incident thereon into a fourth laser beam having an annular cross section; and
a second focusing optical element for focusing the fourth laser beam in a second predetermined location so as to generate a Bessel beam.

8. The optical device according to claim 7, wherein the second beam shaping unit comprises a transmissive optical element.

9. The optical device according to claim 8, wherein the transmissive optical element is a convex axicon lens.

10. The optical device according to claim 7, wherein the second beam shaping unit comprises a reflective optical element.

11. The optical device according to claim 10, wherein the reflective optical element includes at least one of a concave axicon mirror and a convex axicon mirror.

12. The optical device according to claim 7, wherein the second focusing optical element is a convex axicon lens.

13. The optical device according to claim 7, wherein the first focusing optical element is a diffraction grating.

14. The optical device according to claim 7, wherein the first and second predetermined locations substantially coincide with each other.

15. The optical device according to claim 7, wherein the first and second predetermined locations differ from each other.

16. The optical device according to claim 7, further comprising an optical system disposed on a beam path of the second and fourth laser beams such that respective beam axes of the second and fourth laser beams outputted respectively from the first and second beam shaping units coincide with each other.

17. The optical device according to claim 16, wherein the first and second focusing optical elements are disposed substantially coaxially.

18. A laser apparatus, comprising:
the optical device according to claim 1; and
at least one laser unit.

19. An extreme ultraviolet light generation system, comprising:
the optical device according to claim 1;
a laser apparatus including at least one laser unit;
a chamber provided with at least one inlet for introducing a laser beam outputted from the laser apparatus into the chamber;
a target supply unit for supplying into the chamber a target material to be irradiated by the laser beam in the chamber; and
a collector mirror for selectively reflecting, of light generated as the target material is irradiated by the laser beam, light at a predetermined wavelength.

20. The extreme ultraviolet light generation system according to claim 19, wherein the optical device is disposed inside the chamber.

21. The extreme ultraviolet light generation system according to claim 19, wherein the optical device is disposed outside the chamber.

22. The extreme ultraviolet light generation system according to claim 21, wherein
the at least one inlet is provided with a window,
the window includes a transparent substrate which allows the second and fourth laser beams to be transmitted therethrough, and
respective flat surfaces of the transparent substrate are respectively provided with anti-reflection coatings for preventing at least one of the second and fourth laser beams from being reflected thereby.
